(19) United States
(12) Patent Application Publication
(10) Pub. No.: US 2025/0075289 A1
(43) Pub. Date: Mar. 6, 2025

(54) METHOD FOR PREPARING HIGH-PURITY INDIUM

(71) Applicant: Kunming University of Science and Technology, Kunming City (CN)

(72) Inventors: Lingxin KONG, Kunming City (CN); Jian PANG, Kunming City (CN); Bin YANG, Kunming City (CN); Baoqiang XU, Kunming City (CN); Wenlong JIANG, Kunming City (CN); Junjie XU, Kunming City (CN); Dachun LIU, Kunming City (CN); Yang TIAN, Kunming City (CN); Yong DENG, Kunming City (CN)

(21) Appl. No.: 18/805,621

(22) Filed: Aug. 15, 2024

(30) Foreign Application Priority Data
Aug. 29, 2023 (CN) 202311099056.2

(51) Int. Cl. C22B 58/00; B01D 3/10; B01D 3/42; B01D 5/00; C22B 9/02

(52) U.S. Cl. CPC C22B 58/00; B01D 3/10; B01D 3/42; B01D 5/0045; B01D 5/006; C22B 9/02

(57) ABSTRACT

Provided is a method for preparing high-purity indium (In). The method for preparing the high-purity In includes: distilling refined In to obtain an In vapor-containing gas; and condensing the In vapor-containing gas to obtain the high-purity In; where the distilling is conducted at a temperature of 1,000° C. to 1,100° C. under a vacuum degree of 1.0×10⁻³ Pa to 5.0×10⁻² Pa; and the condensing is conducted at a temperature of 700° C. to 900° C. under a vacuum degree of 1.0×10⁻³ Pa to 5.0×10⁻² Pa. The In vapor-containing gas is obtained by controlling the temperature and vacuum degree of the distilling to evaporate In and impurities with a vapor pressure higher than the In. The temperature and vacuum degree of the condensing are adjusted to condense the In in the In vapor-containing gas.

### CROSS REFERENCE TO RELATED APPLICATION

This patent application claims the benefit and priority of Chinese Patent Application No. 202311099056.2 filed with the China National Intellectual Property Administration on Aug. 29, 2023, the disclosure of which is incorporated by reference herein in its entirety as part of the present application.

### TECHNICAL FIELD

The present disclosure relates to the technical field of purification, and in particular to a method for preparing high-purity indium (In).

### BACKGROUND

As a typical scattered metal, In has excellent properties such as corrosion resistance, light permeability, and strong conductivity. The In is widely used in optoelectronics, chemical industry, medicine, military and other fields, and thus becomes an important strategic material to ensure national economic development and national security.

At present, high-purity In is mainly produced by electrolytic refining, vacuum distillation, and regional smelting. The vacuum distillation has a relatively complicated process flow. For example, Chinese patent CN108085518A requires directional solidification after two-stage vacuum distillation to prepare 5N5 high-purity In.

### SUMMARY

An object of the present disclosure is to provide a method for preparing high-purity In. In the present disclosure, the method for preparing the high-purity In has a short process flow.

To achieve the above object, the present disclosure provides the following technical solutions.

The present disclosure provides a method for preparing high-purity In, including the steps of distilling refined In to obtain an In vapor-containing gas and condensing the In vapor-containing gas to obtain the high-purity In, where the distilling is conducted at a temperature of 1,000° C. to 1,100° C. under a vacuum degree of 1.0×10⁻³ Pa to 5.0×10⁻² Pa, and the condensing is conducted at a temperature of 700° C. to 900° C. under a vacuum degree of 1.0×10⁻³ Pa to 5.0×10⁻² Pa.

In some embodiments, the refined In has a purity of greater than 99.990%; and the refined In includes a high vapor pressure element and a low vapor pressure element, the high vapor pressure element including In and one or more selected from the group consisting of Pb, Bi, Cd, Mg, Tl, Zn, As, and S, and the low vapor pressure element including one or more selected from the group consisting of Sn, Ag, Cu, Fe, Ni, Al, and Si.

In some embodiments, the distilling is conducted for 1 h to 8 h, and the condensing is conducted for 1 h to 8 h.

In some embodiments, the method is conducted in a vacuum distillation apparatus, and the vacuum distillation apparatus is controlled by an intelligent control system, where the intelligent control system has proportional-integral-derivative (PID) regulating and auto-tuning functions, the vacuum distillation apparatus including: a vacuum pump; a molecular pump connected to a cooling water machine and the vacuum pump separately; a high-vacuum corrugated tube connected to the molecular pump, where a baffle valve and a seal are arranged between the molecular pump and the high-vacuum corrugated tube, the baffle valve is arranged at an outlet of the molecular pump, and the seal is configured to seal the baffle valve and the high-vacuum corrugated tube; an ionization gauge, a resistance gauge, and a bleed valve that are arranged on the high-vacuum corrugated tube; a furnace tube connected to the high-vacuum corrugated tube through a water-cooling flange; a heating furnace body traversed by the furnace tube, where the heating furnace body includes a furnace shell and a furnace cavity surrounded by the furnace shell, and the furnace shell is provided with a molecular pump controller and a composite vacuum gauge; and a pressure regulating valve connected to an end of the furnace tube close to the pressure regulating valve through a pipeline; where a vacuum pressure gauge is arranged on the pipeline; the furnace cavity is provided with a furnace mouth for passage of the furnace tube; the furnace cavity is divided into a first constant temperature zone, a second constant temperature zone, a third constant temperature zone, a fourth constant temperature zone, and a fifth constant temperature zone along a direction in which the furnace tube passes through the furnace mouth 18, and an independent temperature measurer is arranged in each of the first to fifth constant temperature zones; and the first to fifth constant temperature zones are independently a cavity surrounded by a thermal insulation material.

In some embodiments, the furnace tube is a quartz tube; and the furnace tube has an outer diameter of 60 mm and a wall thickness of 5 mm.

In some embodiments, a heating element of the heating furnace body is a siliconit; and the thermal insulation material is composed of three layers of alumina ceramic fiber board.

In some embodiments, the furnace shell is a double-layer furnace shell, and an air cooling system is arranged between the double-layer furnace shell.

In some embodiments, the first to fifth constant temperature zones have lengths of 200 mm, 200 mm, 200 mm, 180 mm, and 180 mm, respectively; the first to fifth constant temperature zones have widths of 60 mm, 60 mm, 60 mm, 50 mm, and 50 mm, respectively; and two adjacent constant temperature zones are spaced apart by 50 mm.

The present disclosure provides a method for preparing high-purity In, including the following steps: distilling refined In to obtain an In vapor-containing gas; and condensing the In vapor-containing gas to obtain the high-purity In; where the distilling is conducted at a temperature of 1,000° C. to 1,100° C. under a vacuum degree of 1.0×10⁻³ Pa to 5.0×10⁻² Pa; and the condensing is conducted at a temperature of 700° C. to 900° C. under a vacuum degree of 1.0×10⁻³ Pa to 5.0×10⁻² Pa. The In vapor-containing gas is obtained by controlling the temperature and vacuum degree of the distilling to evaporate In and impurities with a vapor pressure higher than the In. The temperature and vacuum degree of the condensing are adjusted to condense the In in the In vapor-containing gas. At this time, the impurities continue to be gases, thereby achieving the preparation of the high-purity In, with a shortened process flow.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows a schematic structural diagram of the vacuum distillation apparatus used in an example of the present disclosure; and

FIG. 2 shows an internal structure diagram of the heating furnace body for vacuum distillation in an example of the present disclosure.

### DETAILED DESCRIPTION OF THE EMBODIMENTS

The present disclosure provides a method for preparing high-purity In, including the steps of distilling refined In to obtain an In vapor-containing gas and condensing the In vapor-containing gas to obtain the high-purity In. The distilling is conducted at a temperature of 1,000° C. to 1,100° C. under a vacuum degree of 1.0×10⁻³ Pa to 5.0×10⁻² Pa. The condensing is conducted at a temperature of 700° C. to 900° C. under a vacuum degree of 1.0×10⁻³ Pa to 5.0×10⁻² Pa.

In the present disclosure, refined In is distilled to obtain an In vapor-containing gas. In some embodiments of the present disclosure, the refined In has a purity of greater than 99.990%; and the refined In includes a high vapor pressure element and a low vapor pressure element, the high vapor pressure element including In and one or more selected from the group consisting of Pb, Bi, Cd, Mg, Tl, Zn, As, and S, and the low vapor pressure element including one or more selected from the group consisting of Sn, Ag, Cu, Fe, Ni, Al, and Si.

In some embodiments of the present disclosure, the distilling is conducted at a temperature of 1,000° C. to 1,100° C., and preferably 1,050° C. to 1,070° C. In some embodiments of the present disclosure, the distilling is conducted under a vacuum degree of 1.0×10⁻³ Pa to 5.0×10⁻² Pa, preferably 3.0×10⁻³ Pa to 1.0×10⁻² Pa, more preferably 4.0×10⁻³ Pa to 2.0×10⁻² Pa. In some embodiments of the present disclosure, the distilling is conducted for 1 h to 8 h, preferably 2 h to 6 h, and more preferably 4 h to 5 h.

In the present disclosure, after the In vapor-containing gas is obtained, the In vapor-containing gas is condensed to obtain the high-purity In.

In some embodiments of the present disclosure, the condensing is conducted at a temperature of 700° C. to 900° C., and preferably 750° C. to 850° C. In some embodiments of the present disclosure, the condensing is conducted under a vacuum degree of 1.0×10⁻³ Pa to 5.0×10⁻² Pa, and preferably 3.0×10⁻³ Pa to 2.0×10⁻² Pa. In some embodiments of the present disclosure, the condensing is conducted for 1 h to 8 h, preferably 2 h to 6 h, and more preferably 4 h to 5 h.

In some embodiments of the present disclosure, the method is conducted in a vacuum distillation apparatus, and the vacuum distillation apparatus is controlled by an intelligent control system, where the intelligent control system has PID regulating and auto-tuning functions. The vacuum distillation apparatus includes a vacuum pump 1 and a molecular pump 2 connected to a cooling water machine 3 and the vacuum pump 1 separately. The vacuum distillation apparatus can also include a high-vacuum corrugated tube 6 connected to the molecular pump 2, where a baffle valve 4 and a seal 5 are arranged between the molecular pump 2 and the high-vacuum corrugated tube 6. The baffle valve 4 is arranged at an outlet of the molecular pump 2, and the seal 5 is configured to seal the baffle valve 4 and the high-vacuum corrugated tube 6. The vacuum distillation apparatus can also include an ionization gauge 7, a resistance gauge 8, and a bleed valve 9 that are arranged on the high-vacuum corrugated tube 6. A furnace tube 11 can be provided to connected to the high-vacuum corrugated tube 6 through a water-cooling flange 10. The vacuum distillation apparatus can also include a heating furnace body 12 traversed by the furnace tube 11, where the heating furnace body 12 includes a furnace shell 13 and a furnace cavity surrounded by the furnace shell 13, and the furnace shell 13 is provided with a molecular pump controller 16 and a composite vacuum gauge 17. A pressure regulating valve 15 can be provided connected to an end of the furnace tube 11 close to the pressure regulating valve 15 through a pipeline; where a vacuum pressure gauge 14 is arranged on the pipeline and the furnace cavity is provided with a furnace mouth 18 for passage of the furnace tube 11. The furnace cavity can be divided into a first constant temperature zone 20, a second constant temperature zone 21, a third constant temperature zone 22, a fourth constant temperature zone 23, and a fifth constant temperature zone 24 along a direction in which the furnace tube 11 passes through the furnace mouth 18. An independent temperature measurer 25 can be provided in each of the first to fifth constant temperature zones; and the first to fifth constant temperature zones are independently a cavity surrounded by a thermal insulation material 19.

In the present disclosure, a vacuum distillation apparatus includes a vacuum pump 1, and a molecular pump 2 connected to a cooling water machine 3 and the vacuum pump 1 separately. The vacuum pump could pump a vacuum degree of the vacuum distillation apparatus to 0.1 Pa; the molecular pump could pump the vacuum degree of the vacuum distillation apparatus to 6.0×10⁻⁴ Pa; and the cooling water machine cools down the molecular pump and a water-cooling flange 10.

In the present disclosure, the vacuum distillation apparatus includes a high-vacuum corrugated tube 6 connected to the molecular pump 2, where a baffle valve 4 and a seal 5 are arranged between the molecular pump 2 and the high-vacuum corrugated tube 6, the baffle valve 4 is arranged at an outlet of the molecular pump 2, and the seal 5 is configured to seal the baffle valve 4 and the high-vacuum corrugated tube 6. The high-vacuum corrugated tube serves as a connecting device to ensure the passage of gas and impurity elements, and also shows desirable sealing properties to ensure that the pressure in the system is reduced to 6.0×10⁻⁴ Pa. The baffle valve regulates a pumping rate of the furnace tube 11 by the vacuum pump and the molecular pump.

In some embodiments of the present disclosure, the seal 5 includes a stainless steel sealing flange, an “O”-shaped sealing ring, a vacuum pressure gauge, a stainless steel ball valve, and a pagoda mouth machine head. In some embodiments of the present disclosure, the baffle valve 4 is connected to the high-vacuum corrugated tube 6 through the stainless steel sealing flange, “O”-shaped sealing ring, vacuum pressure gauge, stainless steel ball valve, and pagoda mouth machine head in sequence.

In the present disclosure, the vacuum distillation apparatus includes an ionization gauge 7, a resistance gauge 8, and a bleed valve 9 that are arranged on the high-vacuum corrugated tube 6. The ionization gauge 7 is configured to measure a pressure of the system, with a measurement range of 1 Pa to 1,000,000 Pa; the resistance gauge 8 is configured to measure the pressure of the system, with a measurement range of 0.00001 Pa to 1 Pa; and the bleed valve 9 could restore a pressure of the vacuum distillation apparatus to a normal atmospheric pressure after an experiment is completed.

In the present disclosure, the vacuum distillation apparatus includes a furnace tube 11 connected to the high-vacuum corrugated tube 6 through a water-cooling flange 10. In some embodiments of the present disclosure, the furnace tube 11 is a quartz tube; and the furnace tube has an outer diameter of 60 mm, and a wall thickness of 5 mm.

In the present disclosure, the vacuum distillation apparatus includes a heating furnace body 12 traversed by the furnace tube 11, where the heating furnace body 12 includes a furnace shell 13 and a furnace cavity surrounded by the furnace shell 13, and the furnace shell 13 is provided with a molecular pump controller 16 and a composite vacuum gauge 17.

In the present disclosure, the furnace cavity is provided with a furnace mouth 18 for the passage of the furnace tube 11. The furnace cavity is divided into a first constant temperature zone 20, a second constant temperature zone 21, a third constant temperature zone 22, a fourth constant temperature zone 23, and a fifth constant temperature zone 24 along a direction in which the furnace tube 11 passes through the furnace mouth 18. An independent temperature measurer 25 is arranged in each of the first to fifth constant temperature zones; and the first to fifth constant temperature zones are independently a cavity surrounded by a thermal insulation material 19.

In some embodiments of the present disclosure, the thermal insulation material 19 is composed of three layers of alumina ceramic fiber board. The thermal insulation material composed of the three layers of alumina ceramic fiber board could not only ensure sufficient strength of the furnace cavity but also ensure heat preservation of the furnace cavity.

In some embodiments of the present disclosure, the furnace mouth 18 is covered with a Japanese Alcera high-temperature fiber blanket.

In some embodiments of the present disclosure, a heating element of the heating furnace body 12 is a siliconit.

An integration of the heating element, thermal insulation material, and 5 independent constant temperature zones enables each independent constant temperature zone to have a temperature up to 1,400° C.

In some embodiments of the present disclosure, the furnace shell 13 is a double-layer furnace shell, and an air cooling system is arranged between the double-layer furnace shell.

In some embodiments of the present disclosure, the first to fifth constant temperature zones have lengths of 200 mm, 200 mm, 200 mm, 180 mm, and 180 mm, respectively; the first to fifth constant temperature zones have widths of 60 mm, 60 mm, 60 mm, 50 mm, and 50 mm, respectively; and two adjacent constant temperature zones are spaced apart by 50 mm.

In some embodiments of the present disclosure, the furnace shell 13 is further provided with first to fifth temperature controllers for controlling temperatures of the first to fifth constant temperature zones; the first to fifth constant temperature zones have independently a temperature of 0° C. to 1,400° C., and independently a heating rate of 0° C./min to 20° C./min.

In the present disclosure, the vacuum distillation apparatus further includes an instrument panel. In some embodiments of the present disclosure, the instrument panel is arranged on the furnace shell 13.

In the present disclosure, the vacuum distillation apparatus further includes a pressure regulating valve 15 connected to an end of the furnace tube 11 close to the pressure regulating valve 15 through a pipeline. In some embodiments of the present disclosure, the end of the furnace tube 11 close to the pressure regulating valve 15 is connected to a pipeline through the water-cooling flange 10.

In the present disclosure, the vacuum distillation apparatus is sealably connected in the sealed manner through the vacuum pump 1, the molecular pump 2, the baffle valve 4, the seal 5, the high-vacuum corrugated tube 6, and the furnace tube 11, such that the vacuum distillation apparatus achieves a vacuum degree of 6.0×10⁻⁴ Pa to 9×10⁴ Pa.

An intake rate of high-purity argon could be adjusted through the pressure regulating valve 15 in combination with the vacuum pressure gauge 14 and the composite vacuum gauge 17 to achieve precise control of the pressure in the vacuum distillation apparatus.

The instrument panel, the composite vacuum gauge 17, the temperature measurer 25, the ionization gauge 7, and the resistance gauge 8 could visually display the pressure and temperature in the system.

In some embodiments of the present disclosure, a working voltage is 380 V, and a working frequency is 50 Hz.

In some embodiments of the present disclosure, the distilling is conducted in the third constant temperature zone. The In vapor-containing gas could volatilize from the third constant temperature zone and enter the second constant temperature zone and the fourth constant temperature zone to achieve condensation of In. Remaining impurities in the In vapor-containing gas could enter the first constant temperature zone and the fifth constant temperature zone and are subjected to condensation.

In the present disclosure, an intake rate of high-purity argon could be adjusted through the pressure regulating valve 15 in combination with the vacuum pressure gauge 14 and the composite vacuum gauge 17 to achieve precise control of the pressure in the system.

In some embodiments of the present disclosure, the method includes steps when being conducted in the vacuum distillation apparatus. The steps can include opening a water-cooling flange 10, placing a high-purity graphite crucible containing the refined In into the furnace tube 11 in the third constant temperature zone, and then closing the water-cooling flange; turning on the cooling water machine 3, furnace body air cooling system, and vacuum pump 1 in sequence; when a display of the composite vacuum gauge 17 is lower than 10 Pa, opening the molecular pump 2 to pump the vacuum degree in the vacuum distillation apparatus to a vacuum degree of distillation and condensation, and stabilizing the vacuum degree in the vacuum distillation apparatus by the pressure regulating valve 15. Other steps can include turning on heating systems of the second temperature controller, third temperature controller, and fourth temperature controller, and controlling a heating rate to 0° C./min to 20° C./min, where when the third constant temperature zone is heated to a distillation temperature, In and other high vapor pressure impurity elements volatilize during the distillation; low vapor pressure impurity elements do not volatilize and remain in the crucible, and the In volatilized from the furnace tube 11 located in the third constant temperature zone is condensed in a position of the furnace tube 11 located in the second constant temperature zone and the fourth constant temperature zone; impurity elements with a vapor pressure greater than that of In continue to volatilize and condense in a position of the furnace tube 11 located in the first constant temperature zone and the fifth constant temperature zone. After the condensation is completed, other steps can include turning off the heating systems of the second temperature controller, third temperature controller, and fourth temperature controller, and cooling to room temperature within 3 h to 5 h; turning off the molecular pump, vacuum pump, circulating water machine, and air cooling system in sequence; and opening the water-cooling flange 10 and taking out the volatile matters and residues in the quartz tube 11.

The method for preparing high-purity In provided by the present disclosure is described in detail below in conjunction with the examples, but these examples should not be understood as limiting the scope of the present disclosure.

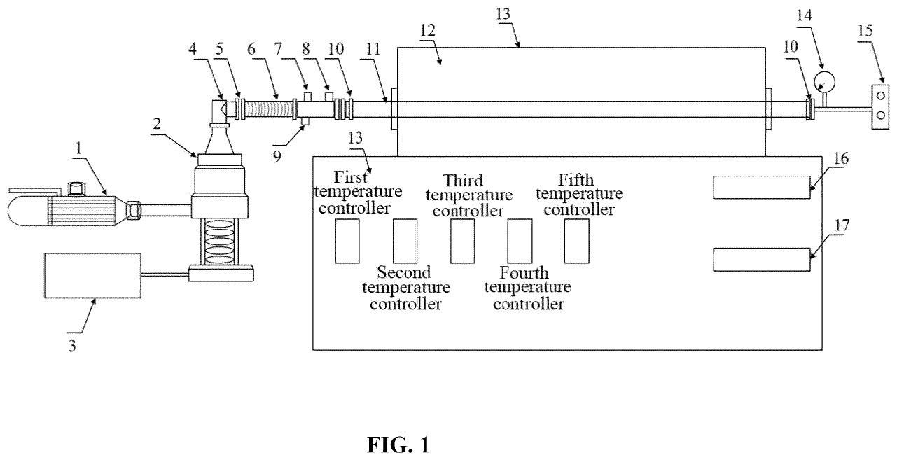

A vacuum distillation apparatus used in the example of the present disclosure is shown in FIG. 1, which is controlled by an intelligent control system. The vacuum distillation apparatus includes a vacuum pump 1 and a molecular pump 2 connected to a cooling water machine 3 and the vacuum pump 1 separately. The vacuum distillation apparatus can also include a high-vacuum corrugated tube 6 connected to the molecular pump 2, where a baffle valve 4 and a seal 5 are arranged between the molecular pump 2 and the high-vacuum corrugated tube 6. The baffle valve 4 is arranged at an outlet of the molecular pump 2, and the seal 5 is configured to seal the baffle valve 4 and the high-vacuum corrugated tube 6. The vacuum distillation apparatus can also include an ionization gauge 7, a resistance gauge 8, and a bleed valve 9 that are arranged on the high-vacuum corrugated tube 6. A furnace tube 11 can be provided to connected to the high-vacuum corrugated tube 6 through a water-cooling flange 10. The vacuum distillation apparatus can also include a heating furnace body 12 traversed by the furnace tube 11, where the heating furnace body 12 includes a furnace shell 13 and a furnace cavity surrounded by the furnace shell 13, and the furnace shell 13 is provided with a molecular pump controller 16 and a composite vacuum gauge 17. A pressure regulating valve 15 can be connected to an end of the furnace tube 11 close to the pressure regulating valve 15 through a pipeline; where a vacuum pressure gauge 14 is arranged on the pipeline and the furnace cavity is provided with a furnace mouth 18 for passage of the furnace tube 11. The furnace cavity can be divided into a first constant temperature zone 20, a second constant temperature zone 21, a third constant temperature zone 22, a fourth constant temperature zone 23, and a fifth constant temperature zone 24 along a direction in which the furnace tube 11 passes through the furnace mouth 18. An independent temperature measurer 25 can be arranged in each of the first to fifth constant temperature zones; and the first to fifth constant temperature zones are independently a cavity surrounded by a thermal insulation material 19.

The furnace shell 13 is further provided with first to fifth temperature controllers for controlling temperatures of the first to fifth constant temperature zones and an instrument panel.

The thermal insulation material 19 is composed of three layers of alumina ceramic fiber board; the furnace mouth 18 is covered with a Japanese Alcera high-temperature fiber blanket.

The furnace tube 11 is a quartz tube; and the furnace tube has an outer diameter of 60 mm and a wall thickness of 5 mm.

The furnace shell 13 is a double-layer furnace shell, and an air cooling system is arranged between the double-layer furnace shell.

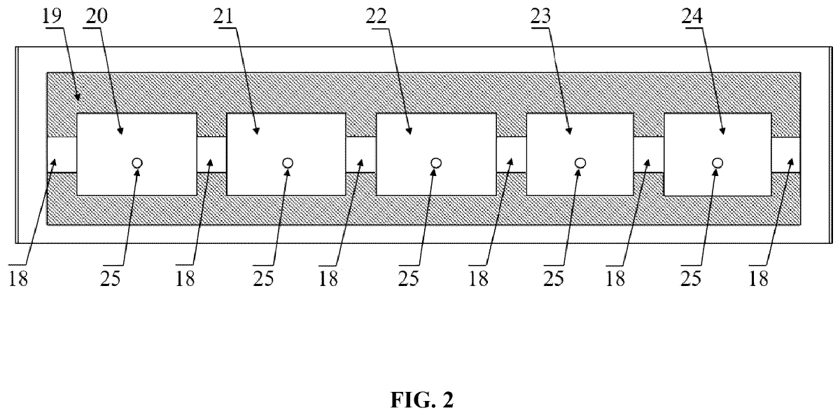

an internal structure of the heating furnace body 12 is shown in FIG. 2, and a heating element of the heating furnace body 12 is a siliconit.

The first to fifth constant temperature zones have lengths of 200 mm, 200 mm, 200 mm, 180 mm, and 180 mm, respectively; the first to fifth constant temperature zones have widths of 60 mm, 60 mm, 60 mm, 50 mm, and 50 mm, respectively; and two adjacent constant temperature zones are spaced apart by 50 mm.

### Example 1

The water-cooling flange 10 was opened. A high-purity graphite crucible having 200 g of refined In with a purity of 99.990% was placed in a position of the quartz tube 11 in the third constant temperature zone. Then the water-cooling flange was closed. The cooling water machine 3, the furnace body air cooling system, and the vacuum pump 1 were turned on in sequence. When the composite vacuum gauge 17 showed a display of lower than 10 Pa, the molecular pump 2 was opened to pump a vacuum degree in the vacuum distillation apparatus to 2.0×10⁻³ Pa, and the pressure regulating valve 15 was opened to stabilize the pressure in the system at 2.0×10⁻³ Pa. Heating systems of the second temperature controller, the third temperature controller, and the fourth temperature controller were turned on, and a heating rate was controlled to 0° C./min to 20° C./min. When the third constant temperature zone was heated to 1,000° C., the second constant temperature zone and the fourth constant temperature zone were heated to 900° C., the refined In was distilled and condensed for 8 h. During the distillation, In and high vapor pressure impurity elements volatilized; low vapor pressure impurity elements did not volatilize and remained in the crucible. In volatilized from the third constant temperature zone was condensed in a position of the quartz tube 11 located in the second constant temperature zone and the fourth constant temperature zone; impurity elements with a vapor pressure greater than that of In continued to volatilize and condense into a positions of the quartz tube 11 located in the first constant temperature zone and the fifth constant temperature zone. After the condensation was completed, the heating systems of the second temperature controller, third temperature controller, and fourth temperature controller were turned off, and cooled to room temperature. The molecular pump, vacuum pump, circulating water machine, and air cooling system were turned off in sequence. The water-cooling flange 10 was opened, and high-purity In and residues in the quartz tube 11 were taken out, the high-purity In was subjected to GDMS detection, and the high-purity In had a purity of 99.9994%.

### Example 2

This example differed from Example 1 only in that: the system had a pressure of 3.0×10⁻² Pa, the third constant temperature zone was at 1,050° C., the second constant temperature zone and the fourth constant temperature zone each were at 850° C.; and the distillation and condensation were conducted for 5 h.

The high-purity In was subjected to GDMS detection, and the high-purity In had a purity of 99.9993%.

### Example 3

This example differed from Example 1 only in that: the refined In had a purity of 99.995%; the system had a pressure of 1.0×10⁻³ Pa, the third constant temperature zone was at 1,075° C., the second constant temperature zone and the fourth constant temperature zone each were at 800° C.; and the distillation and condensation were conducted for 4 h.

The high-purity In was subjected to GDMS detection, and the high-purity In had a purity of 99.9995%.

### Example 4

This example differed from Example 1 only in that: the refined In had a purity of 99.995%; the system had a pressure of 5.0×10⁻² Pa, the third constant temperature zone was at 1,100° C., the second constant temperature zone and the fourth constant temperature zone each were at 700° C.; and the distillation and condensation were conducted for 3 h.

The high-purity In was subjected to GDMS detection, and the high-purity In had a purity of 99.9994%.

### Example 5

This example differed from Example 1 only in that: the refined In had a purity of 99.995%; the system had a pressure of 3.0×10⁻² Pa, the third constant temperature zone was at 1,100° C., the second constant temperature zone and the fourth constant temperature zone each were at 750° C.; and the distillation and condensation were conducted for 2 h.

The high-purity In was subjected to GDMS detection, and the high-purity In had a purity of 99.9994%.

### Example 6

This example differed from Example 1 only in that: the refined In had a purity of 99.995%; the system had a pressure of 6.0×10⁻³ Pa, the third constant temperature zone was at 1,100° C., the second constant temperature zone and the fourth constant temperature zone each were at 800° C.; and the distillation and condensation were conducted for 1 h.

The high-purity In was subjected to GDMS detection, and the high-purity In had a purity of 99.9994%.

The above descriptions are merely preferred implementations of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. A method for preparing high-purity indium (In), comprising the following steps:
distilling refined In to obtain an In vapor-containing gas; and
condensing the In vapor-containing gas to obtain the high-purity In,
wherein the distilling is conducted at a temperature of 1,000° C. to 1,100° C. under a vacuum degree of 1.0×10⁻³ Pa to 5.0×10⁻² Pa, and the condensing is conducted at a temperature of 700° C. to 900° C. under a vacuum degree of 1.0×10⁻³ Pa to 5.0×10⁻² Pa.

2. The method according to claim 1, wherein the refined In has a purity of greater than 99.990%; and the refined In comprises a high vapor pressure element and a low vapor pressure element, the high vapor pressure element comprising In and one or more selected from the group consisting of Pb, Bi, Cd, Mg, Tl, Zn, As, and S, and the low vapor pressure element comprising one or more selected from the group consisting of Sn, Ag, Cu, Fe, Ni, Al, and Si.

3. The method of claim 1, wherein the distilling is conducted for 1 h to 8 h, and the condensing is conducted for 1 h to 8 h.

4. The method of claim 1, wherein the method is conducted in a vacuum distillation apparatus, and the vacuum distillation apparatus is controlled by an intelligent control system, wherein the intelligent control system has proportional-integral-derivative (PID) regulating and auto-tuning functions, the vacuum distillation apparatus comprising:
a vacuum pump;
a molecular pump connected to a cooling water machine and the vacuum pump separately;
a high-vacuum corrugated tube connected to the molecular pump, wherein a baffle valve and a seal are arranged between the molecular pump and the high-vacuum corrugated tube, the baffle valve is arranged at an outlet of the molecular pump, and the seal is configured to seal the baffle valve and the high-vacuum corrugated tube;
an ionization gauge, a resistance gauge, and a bleed valve that are arranged on the high-vacuum corrugated tube;
a furnace tube connected to the high-vacuum corrugated tube through a water-cooling flange;
a heating furnace body traversed by the furnace tube, wherein the heating furnace body comprises a furnace shell and a furnace cavity surrounded by the furnace shell, and the furnace shell is provided with a molecular pump controller and a composite vacuum gauge; and
a pressure regulating valve connected to an end of the furnace tube close to the pressure regulating valve through a pipeline; wherein
a vacuum pressure gauge is arranged on the pipeline;
the furnace cavity is provided with a furnace mouth for passage of the furnace tube; and
the furnace cavity is divided into a first constant temperature zone, a second constant temperature zone, a third constant temperature zone, a fourth constant temperature zone, and a fifth constant temperature zone along a direction in which the furnace tube passes through the furnace mouth, and an independent temperature measurer is arranged in each of the first to fifth constant temperature zones; and the first to fifth constant temperature zones are independently a cavity surrounded by a thermal insulation material.

5. The method of claim 4, wherein the furnace tube is a quartz tube; and the furnace tube has an outer diameter of 60 mm and a wall thickness of 5 mm.

6. The method of claim 4, wherein a heating element of the heating furnace body is a siliconit; and the thermal insulation material is composed of three layers of alumina ceramic fiber board.

7. The method of claim 4, wherein the furnace shell is a double-layer furnace shell, and an air cooling system is arranged between the double-layer furnace shell.

8. The method of claim 4, wherein the first to fifth constant temperature zones have lengths of 200 mm, 200 mm, 200 mm, 180 mm, and 180 mm, respectively; the first to fifth constant temperature zones have widths of 60 mm, 60 mm, 60 mm, 50 mm, and 50 mm, respectively; and two adjacent constant temperature zones are spaced apart by 50 mm.

9. The method of claim 4, wherein the refined In has a purity of greater than 99.990%; and the refined In comprises a high vapor pressure element and a low vapor pressure element, the high vapor pressure element comprising In and one or more selected from the group consisting of Pb, Bi, Cd, Mg, Tl, Zn, As, and S, and the low vapor pressure element comprising one or more selected from the group consisting of Sn, Ag, Cu, Fe, Ni, Al, and Si.

10. The method of claim 4, wherein the distilling is conducted for 1 h to 8 h, and the condensing is conducted for 1 h to 8 h.
